(19) United States
(12) Patent Application Publication
(10) Pub. No.: US 2005/0253084 A1
(43) Pub. Date: Nov. 17, 2005

(54) Ion generation apparatus used in ion implanter

(76) Inventor: Seung-Man Nam, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/092,068

(22) Filed: Mar. 28, 2005

(30) Foreign Application Priority Data
May 12, 2004 (KR) 2004-33591

(51) Int. Cl. H01J 27/00

(52) U.S. Cl. 250/423 R

(57) ABSTRACT

An ion generation apparatus used in an ion implanter includes a source head for generating ions and a source chamber with a manipulator for extracting only cations from the generated ions. A liner comprising a plurality of sections is installed at inner faces of the source chamber. An existing liner can be periodically replaced with a new liner to shorten a time required for cleaning the inner faces of the source chamber.

### PRIORITY STATEMENT

This application claims priority of Korean Patent Application No. 2004-33591, filed on May 12, 2004 in the Korean Intellectual Property Office, the disclosure of which is incorporated herein in its entirety by reference.

### BACKGROUND OF THE INVENTION

1. Field of the Invention

The present invention relates to an apparatus for manufacturing semiconductor devices and, more particularly, to an ion generation apparatus used in an ion implanter for implanting ions onto a wafer.

2. Description of Related Art

Ion implantation involves p-type impurities such as boron (B), aluminum (Al), and indium (In) and n-type impurities such as stibium (Sb), phosphorus (P), and arsenic (As). These impurities are converted into an ion-beam-state. Then, they are implanted into semiconductor crystals to obtain desired-conduction-type and resistivity devices. The ion implantation has been used widely because the concentration of impurities implanted into a wafer can be readily controlled.

An ion implanter used in the above-mentioned ion implantation comprises a source head for generating ions and a manipulator with an extraction electrode for extracting only cations from the generated ions. The manipulator is disposed in a source chamber. An opening is formed at the source chamber. An extracted ion beam is supplied to a beam line part through the opening of the source chamber. If the process is performed for a predetermined time period, the ion beam material which is deposited on an inner wall of the source chamber can cause an arching therein. The energy and the uniformity of the ion beam varies with the arching, resulting in faulty process operation.

For this reason, if a process is performed during a predetermined period, a cleaning process is performed to remove ion beam fume materials deposited on an inner wall of a source chamber. In order to clean a source chamber, a worker scrubs the inner walls of the source chamber using a wiper soaked with deionized water (DI water) or oxygenated water. However, cleaning may not be fully complete if DI water is used. Also, workers may encounter a risk of danger in the case where oxygenated water is used. As previously stated, in the case where the worker scrubs an inner wall of a source chamber, a great deal of cleaning time is required which substantially lowers the effective operating rate of the system.

### SUMMARY OF THE INVENTION

The present invention is directed to an ion implanting process which employs an ion generation apparatus that shortens the time required for cleaning a source chamber and thereby enhances the system operating rate. The ion implanting process is used for a semiconductor substrate. The process comprises providing the ion generation apparatus which comprises a source head for generating ions from a gas, and a source chamber including a manipulator for extracting only cations from the ions generated from the source head. The source chamber has an opening for supplying an extracted ion beam to a beam line portion. A liner is provided for surrounding the inner wall of the source chamber for preventing the ions from being deposited on an inner wall of the source chamber. Preferably, the liner is made of graphite. Moreover, the liner is preferably removable from the source chamber. The liner can also comprise a plurality of sections corresponding to the configuration of at least one of the inner walls of the source chamber. The plurality of the sections are disposed to allow the edges of adjacent sections to overlap one another. Preferably, each of the sections is fixed to the inner wall of the source chamber employing an attachment device.

### BRIEF DESCRIPTION OF THE DRAWINGS

FIG. 1 is a flow diagram which illustrates an ion implanter which employs an ion generation apparatus according to an embodiment of the present invention.

FIG. 2 is a cross-sectional schematic view of an ion generation apparatus according an aspect of to the present invention.

FIG. 3 is a cross-sectional schematic view of a source head shown in FIG. 2.

FIG. 4 illustrates various sections of a liner.

FIG. 5 illustrates the inside of a chamber without a liner.

FIG. 6 illustrates the inside of a chamber with a liner.

### DETAILED DESCRIPTION OF THE PREFERRED EMBODIMENTS

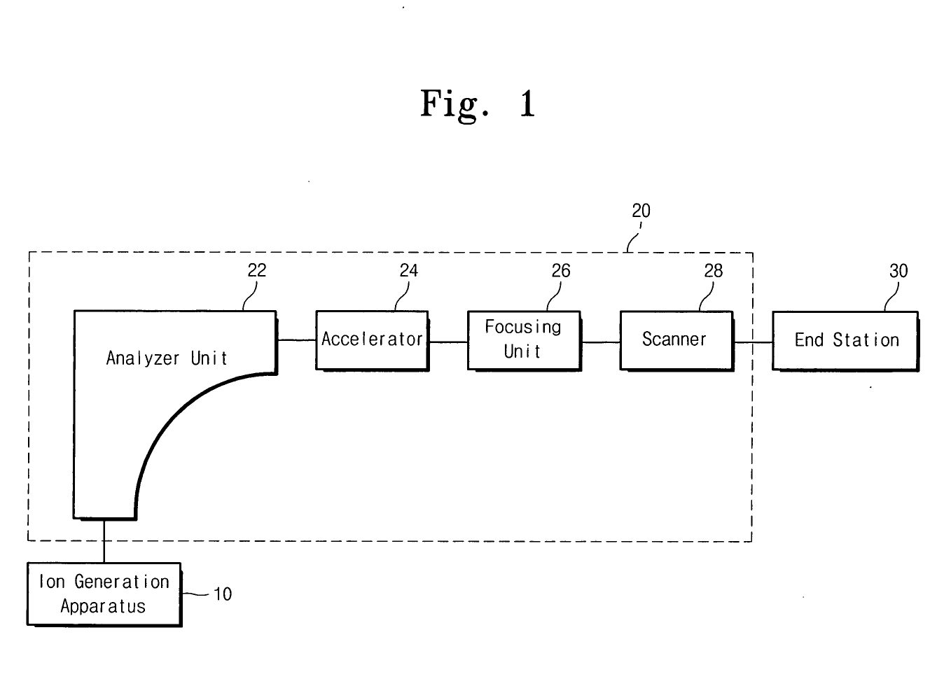

An ion implanter using an ion generation apparatus 10 according to the present invention is schematically illustrated in FIG. 1. The ion implanter includes the ion generation apparatus 10 for generating ion beam, a beam line assembly 20 where the ion beam is focused and accelerated, and an end station 30 where the ion beam is implanted to a wafer. The beam line assembly 20 includes an analyzer unit 22, an accelerator 24, a focusing unit 26, and a scanner 28. The analyzer unit 22 uses a mass analyzer to select desired-atomic-weight ions to be implanted to a wafer among the ions generated from the ion generation apparatus 10. The accelerator 24 accelerates the selected ions having energy to implant them up to a desired depth of a wafer. The focusing unit 26 focuses the ion beam to prevent the ion beam from being propagated due to a repulsive force when neutral ions are ionized to migrate. The scanner 28 changes a migration direction of the ion beam in an up-and-down and left-and-right direction in order to uniformly distribute the ion beam.

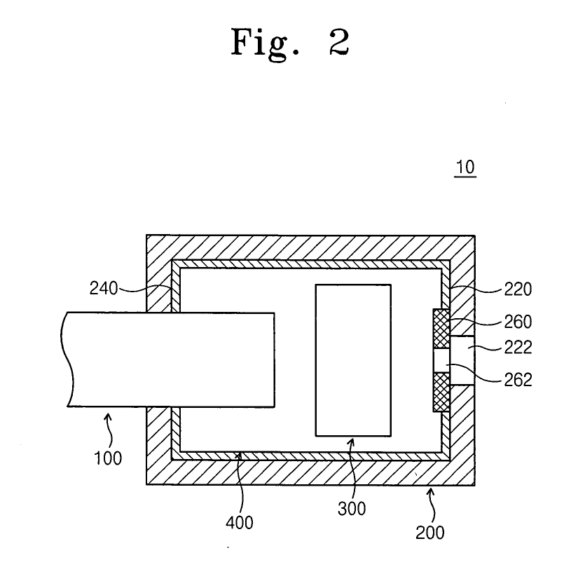

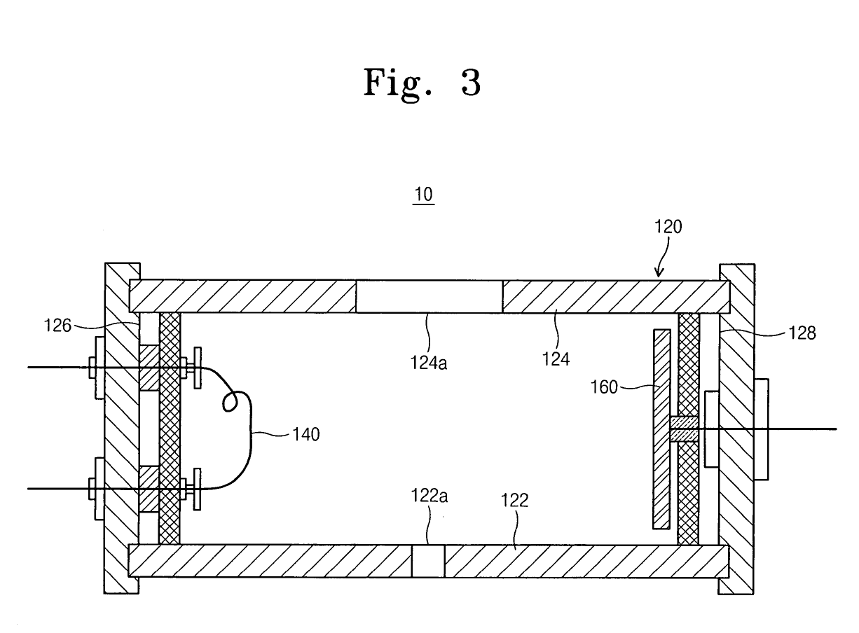

Referring to FIG. 2 and FIG. 3, an ion generation apparatus 10 includes a source head 100, a source chamber 200, a manipulator 300, and a liner 400. The source head 100 has a body 120 having a rectangular parallelepiped shape. An inflow port 122a is formed at a rear face of the body 120. A supply pipe for supplying gas to the body 120 is inserted into the inflow port 122a. An outflow port 124a is formed at a front face 124 of the body 120. The outflow port 124a is a slit-shaped path through which ion beam generated in the body 120 is emitted. A coil-type filament 140 is disposed at one side of the body 120. A filament power source (not shown) is connected to the filament 140, applying a negative electrode to emit hot electrons. The emitted hot electrons collide with the gas flowing into the body 120 to cationize the gas. A repealer 160 is disposed at the other side of the body 120. In order to apply negative current to the repealer 160, an external power source is connected to the repealer 160. Among the hot electrons emitted from the filament 140, non-colliding electrons are pushed out by a repulsive force of the repealer 160 in order that they collide with the gas.

The manipulator 300 is disposed in front of the source head 100 and has an extraction electrode to which a negative power is applied, extracting only cations from the ions generated from the source head 100. While passing the outflow port 114a, the ions extracted from the source head 100 change into ion beam. The ion beam is supplied to the above-mentioned beam line portion 20 through the manipulator 300.

The source head 100 is inserted into the source chamber 200, and the manipulator 300 is disposed in the source chamber 200. An insertion hole is formed at a rear face 240 of the source chamber 200, and a gate hole 222 is formed at a front face 220 thereof. The source head 100 is inserted into the insertion hole. The gate hole 222 is a path through which extracted beams are supplied to the beam line portion 20. In the front face 220 of the source chamber 200, a circular plate 260, typically made of graphite, is attached around the gate hole 222 to prevent the source chamber 200 from being damaged due to collision of the ion beam.

During a process, the ion beam extracted from the source head 100 are partly deposited on inner faces of the source chamber 200 which causes an arching effect. Due to the arching effect, the uniformity of the ion beam varies resulting in defects in the manufacturing process. Thus, a cleaning process is needed to periodically clean the inner walls of the source chamber 200. There will, however, be a loss of processing time required for conducting the cleaning process.

Liner 400 is used to shorten the time required for cleaning the inner faces of the source chamber 200. Since the liner 400 is installed so that it surrounds the inner walls of the source chamber 200, ion beam material is deposited on the liner 400 instead of the inner walls of the source chamber 200. The liner is removable from the inner walls of the source chamber 200. A worker can replace the liner 400 on a periodic basis.

Conventionally, a worker must clean the surfaces of the inner face of a source chamber 200. Therefore, significant amounts of time are required for conducting the cleaning process in order to compensate for losses in the system operating rate. However, according to the present invention, the liner 400 can be readily removed from the source chamber 200. And, in this case, only the liner 400 is cleaned. This is more convenient, and takes a shorter amount of time, than directly cleaning the inner walls of the source chamber. After removing the liner 400 from the source chamber 200, a new liner 400 is attached to the source chamber 200, and the process may be again performed thereby enhancing the system operating rate.

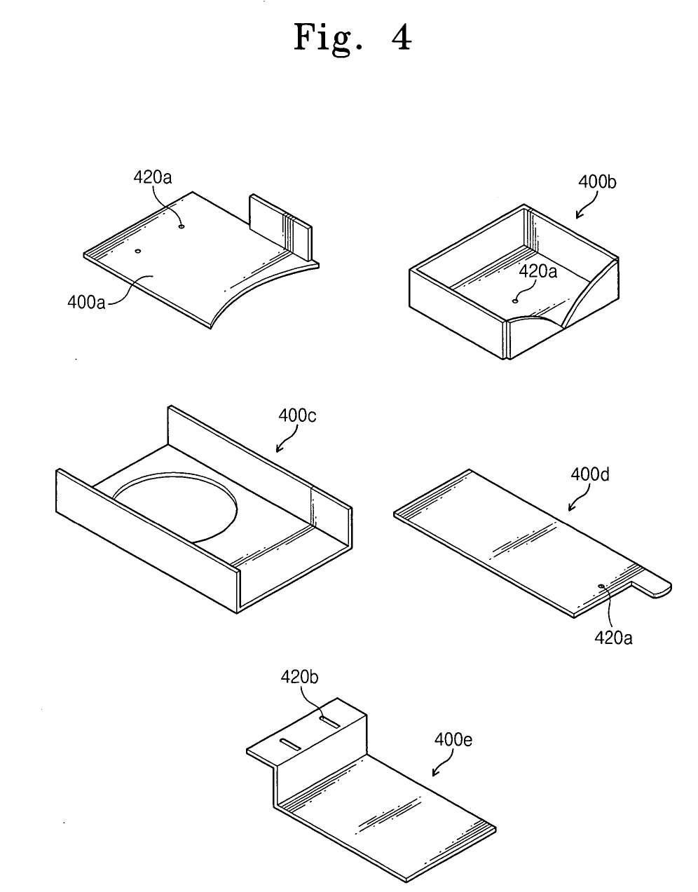

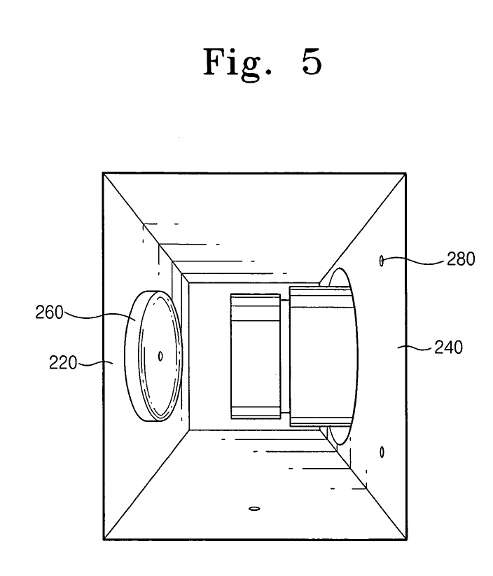

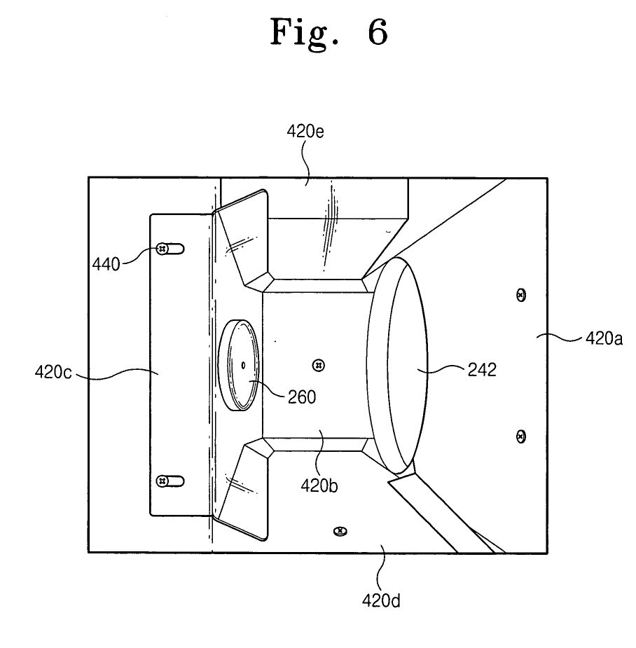

The liner 400 can comprise a plurality of sections 400a, 400b, 400c, 400d, and 400e, each corresponding to the surface configuration of the inner faces of the source chamber 200. FIG. 4 illustrates examples of the sections of the liner 400. FIG. 5 illustrates the inside of the source chamber 200 without the liner 400. FIG. 6 illustrates the inside of the source chamber 200 with the liner 400.

Referring to FIG. 4 through FIG. 6, the sections 400a, 400b, 400c, 400d, and 400e, are installed at the inner walls of the source chamber 200 by means of an attachment means such as a screw or the like. Holes 420a and 420b are formed at the respective sections 400a, 400b, 400c, 400d, and 400e. The screw (440 of FIG. 5) is inserted into the holes 420a and 420b. A screw groove (280 of FIG. 5) is formed in the inner wall of the source chamber 200 at a point opposite to the holes 420a and 420b. Each of the sections 400a, 400b, 400c, 400d, and 400e, respectively, has a larger area than the inner side of the source chamber 200. When they are installed at the source chamber 200, their respective edges are folded to overlap one another. In order to readily install the sections 400a, 400b, 400c, 400d, and 400e, the holes 420a are sized to correspond to a size of the screw and a portion of holes 420a are formed of a slit. The liner 400 may have a unitary structure according to the shape of the source chamber 200, and section may be installed at a plurality of inner faces.

Although the liner 400 is preferably made of graphite having a high strength and a superior conductivity, it may be made of a metal such as aluminum or SUS. Any contamination caused by the use of certain metallic materials is not present in the case where the liner 400 is made of graphite.

If a worker scrubs the inner faces of a source chamber 200 without a liner 400 using a wiper soaked with oxygenated water, the cleaning is not readily conducted, and deposition residues remain at the inner walls thereof even after the cleaning. This is because the cleaning operation is conducted by the use of physical force by the worker. Moreover, the oxygenated water stimulates the skin and respiratory organs of the worker. If the liner 400 of this embodiment is used, these problems may be solved. Further, since a liner is replaced with a new liner, it is not necessary to clean the inner face of a source chamber and thus the cleaning time is significantly shortened. For example, while the cleaning time according to the conventional cleaning approach is about 240 minutes, the cleaning time employing the liner 400 according to the present invention is about 30 minutes.

In summary, by employing the teachings of the present invention, the time required for cleaning the inner walls of a source chamber is significantly shortened thereby enhancing the system operating rate. Furthermore, when using the subject system and method, a worker need not rub the inner walls of the source chamber using a wiper soaked with oxygenated water, thereby preventing the worker from encountering any physical danger caused by the use of oxygenated water. And, since the liner 400 typically comprises a plurality of sections each being installed at the inner faces of the source chamber, it is readily removable.

Other modifications and variations to the invention will be apparent to a person skilled in the art from the foregoing disclosure. Thus, while only certain embodiment of the invention has been specifically described herein, it will be apparent that numerous modifications may be made thereto without departing from the spirit and scope of the invention.

1. An ion generation apparatus used in an ion implanting process for a semiconductor substrate, the apparatus comprising:
a source head for generating ions from a gas;
a source chamber including a manipulator for extracting only cations from the ions generated from the source head, the source chamber having an opening for supplying an extracted ion beam to a beam line portion; and
a liner for preventing the ions from being deposited on an inner wall of the source chamber, the liner being disposed to surround the inner wall of the source chamber.

2. The apparatus of claim 1, wherein the liner is made of graphite.

3. The apparatus of claim 1, wherein the liner is removable from the source chamber.

4. The apparatus of claim 3, wherein the liner comprises a plurality of sections and corresponds to the configuration of at least one of the inner walls of the source chamber.

5. The apparatus of claim 4, wherein the plurality of the sections are disposed so that the edges of adjacent sections overlap each other.

6. The apparatus of claim 4, wherein each of the sections are connected to the inner wall of the source chamber employing an attachment device.

7. An ion generation apparatus used in an ion implanting process for a semiconductor substrate, the apparatus comprising:
a source head for generating ions from a gas;
a source chamber including a manipulator with an extraction electrode for extracting cations from the ions generated from the source head, the source chamber having an opening for supplying the extracted ions to a beam line portion; and
a removable liner for preventing the ions from being deposited on an inner wall of the source chamber, the liner being disposed to surround the inner wall of the source chamber.

8. The apparatus of claim 7, wherein the liner is made of graphite.

9. The apparatus of claim 7, wherein the liner is removable from the source chamber.

10. The apparatus of claim 9, wherein the liner comprises a plurality of sections corresponding to the configuration of at least one of the inner walls of the source chamber.

11. The apparatus of claim 10, wherein the plurality of the sections are disposed to allow the edges of adjacent sections to overlap one another.

12. The apparatus of claim 10, wherein each of the sections is fixed to the inner wall of the source chamber employing an attachment device.

13. The method of claim 12, wherein the attachment device comprises a screw.

14. An ion implanting process for a semiconductor substrate, comprising:
providing an ion generation apparatus for use in the ion implanting process, the apparatus comprising a source head for generating ions from a gas, and a source chamber including a manipulator for extracting only cations from the ions generated from the source head, the source chamber having an opening for supplying an extracted ion beam to a beam line portion; and
providing a liner and surrounding the inner wall of the source chamber for preventing the ions from being deposited on an inner wall of the source chamber.

15. The method of claim 14, wherein the liner is made of graphite.

16. The method of claim 14, wherein the liner is removable from the source chamber.

17. The method of claim 16, wherein the liner comprises a plurality of sections corresponding to the configuration of at least one of the inner walls of the source chamber.

18. The method of claim 17, wherein the plurality of the sections are disposed to allow the edges of adjacent sections to overlap one another.

19. The method of claim 17, wherein each of the sections is fixed to the inner wall of the source chamber employing an attachment device.

20. The method of claim 19, wherein the attachment device comprises a screw.
